(19) United States
(12) Patent Application Publication
(10) Pub. No.: US 2026/0327391 A1
(43) Pub. Date: Oct. 22, 2026

(54) POLYAMIDE FOAM PARTICLES AND PROCESS FOR PREPARING POLYAMIDE FOAM PARTICLES

(71) Applicant: BASF SE, Ludwigshafen am Rhein (DE)

(72) Inventors: Daniela LONGO-SCHEDEL, Ludwigshafen am Rhein (DE); Dominik Michael DOERR, Ludwigshafen am Rhein (DE); Ines DEBEAUVAIS DE VASCONCELOS, Ludwigshafen am Rhein (DE); Patrick HOELTING, Ludwigshafen am Rhein (DE); Ilse ASTOR, Ludwigshafen am Rhein (DE); Angelike KELLER, Ludwigshafen am Rhein (DE); Philipp Maximilian JUNG, Ludwigshafen am Rhein (DE)

(21) Appl. No.: 19/486,487

(22) PCT Filed: May 17, 2024
(86) PCT No.: PCT/EP2024/063708

§ 371 Date: Nov. 21, 2025

(30) Foreign Application Priority Data
May 24, 2023 (EP) 23175010.0

(51) Int. Cl. C08J 9/18; C08J 9/12; C08J 9/14; C08J 9/232

(52) U.S. Cl. CPC C08J 9/18; C08J 9/122; C08J 9/141; C08J 9/232; C08J 2201/032; C08J 2203/06; C08J 2203/14; C08J 2377/00

(57) ABSTRACT

The present invention relates to polyamide foam particles having bulk density in the range from 10 to 95 kg/m³, determined according to DIN ISO 697: 1984 and comprising a polyamide mixture of from 25 to 95 wt.-% of at least one polyamide (A) having a melting point Tm in the range from 205 to 320° C., determined according to ISO 3146:2022, and from 5 to 75 wt.-% of at least one polyamide (B) having a melting point Tm in the range from 150 to 204° C., determined according to ISO 3146:2022, wherein the sum of the polyamides (A) and (B) are 100 wt.-%, and a process for preparing polyamide foam particles and polyamide particle foam moldings.

The present invention relates to polyamide foam particles, a process for preparing polyamide foam particles and polyamide particle foam moldings made therefrom.

### RELEVANT PRIOR ART

US 2018/0044497 discloses a polyamide resin foam shaped product containing a polyamide resin and having a crystallinity X of 10% to 50% and a crystallite size D of 10 nm or more as calculated based on a peak having a smallest peak width in an X-ray diffraction profile of the foam shaped product, and a method of producing this polyamide resin foam shaped product.

WO 2022/085538 provides a method for producing polyamide-based resin multi-stage-expanded particles each having a low density, which makes it possible to perform multi-stage expansion in which an inner pressure is applied to polyamide-based resin expanded particles under a lower-temperature condition than those employed in the conventional methods or under a short-time condition than those employed in the conventional methods to expand the polyamide-based resin expanded particles, the method having excellent productivity.

US 2011/294910 A1 relates to an expandable pelletized material based on polyamide matrix composed of at least 55% by weight of polyamide with a crystallinity of up to 30% and if appropriate a melting point in the range from 100 to 340° C. and a glass transition temperature in the range from 0 to 150° C., a physical blowing agent composition, and to moldable foams and foam moldings obtainable therefrom, to processes for their production, and also to their use in the automobile industry, airline industry, construction industry, or packaging industry, and/or in the transport sector.

EP 4 108 715 A1 and US 2021/0253818 A1 provide polyamide-based resin expanded beads capable of providing a molded article of polyamide-based resin expanded beads having excellent moldability. The polyamide-based resin is preferably a modified polyamide-based resin modified with one or more compounds selected from a carbodiimide compound, an oxazoline compound, an isocyanate compound, and an epoxy compound. The polyamide-based resin expanded beads have a crystal structure obtained through a crystallization treatment step in which an intrinsic peak of the polyamide-based resin and a high-temperature peak having a peak top temperature on a higher temperature side than a peak top temperature of the intrinsic peak appears in a DSC curve obtained under a predetermined condition.

EP 3 848 408 A1 relates to a polyamide-based resin expanded bead comprising a foam layer formed by expanding a polyamide-based resin, wherein on a first DSC curve has a melting peak (intrinsic peak) having a peak top temperature on a low temperature side equal to or lower than a peak top temperature of a melting peak of the second DSC curve and a melting peak (high temperature peak) having a peak top temperature on a high temperature side exceeding the peak top temperature of the second DSC curve, and, the peak top temperature of the melting peak of the second DSC curve is 180° C. or higher and 280° C. or lower, and the polyamide-based resin expanded bead has an apparent density of 10 to 300 kg/m³ and a closed cell ratio of 85% or more.

EP 3 835 345 A1 discloses polyamide pre-expanded particles having a peak temperature of a maximum endothermic peak of 150° C. or higher and 275° C. or lower on a DSC curve and the width of the maximum endothermic peak is 30° C. or greater and 80° C. or smaller. Fusibility of particles during molding and bending breaking strength is improved by moisturizing the polyamide resin pre-expanded particles as pretreatment before molding.

WO 2017/220671 relates to a process for producing foam particles composed of thermoplastic elastomers having polyamide segments, such as polyether block amide (PEBA), by blowing agent impregnation in suspension and foam particles obtainable by the process. Thermal stability of the polyether block amide particle foam moldings was evaluated at a storge temperature of 110° C.

WO 2015/052020 relates to a method for the production of expanded foam particles from a granular material, composed of the polyester blend comprising a biodegradable polyester and polylactic acid.

WO 2021/052881 A1 discloses polyamide foam particles obtainable with bulk densities in the range from 100 to 500 kg/m³ by a continuous one-step process. Lower bulk densities for the foam particles may be achieved by further expansion with pressurized air or steam. Polyamide particle foam moldings are obtainable by steam-chest molding with high temperature stability which particularly are suitable to pass high temperature conditions like an electrodeposition coating process.

US 2022/0169849 A1 is directed to provide polyamide-based resin pre-expanded particles which can serve as a raw material of a polyamide-based resin foam shaped product having an excellent mechanical strength. Polyamide-based resin pre-expanded particles of the present disclosure contain a polyamide-based resin. The polyamide-based resin pre-expanded particles have an expansion ratio of 1.0 or more, wherein the expansion ratio is a ratio (ρ1/ρ2) of a density ρ1 (g/cm3) to a density ρ2 (g/cm3) after being pressurized with air at 0.9 MPa and then heated for 30 seconds with saturated steam at a temperature higher than a thermal fusion temperature by 5° C.

### SUMMARY OF THE INVENTION

The present invention was made in view of the prior art described above, and the object of the present invention was to provide polyamide foam particles, which are processable on standard steam chest molding equipment to polyamide particle foam moldings with a high closed-cell ratio, high specific heat stability and high specific bending strength. Furthermore, a process should be provided which directly produces polyamide foam particles with bulk densities below 100 kg/m³ without the need of a further expansion step.

The problem was solved by polyamide foam particles (expanded polyamide EPA) having bulk density in the range from 10 to 95 kg/m³, determined according to DIN ISO 697: 1984 and comprise a polyamide mixture of
from 25 to 95 wt.-% of at least one polyamide (A) having a melting point Tm in the range from 205 to 320° C., determined according to ISO 3146:2022 (Plastics—Determination of melting behaviour (melting temperature or melting range) of semi-crystalline polymers by capillary tube and polarizing-microscope methods), and
from 5 to 75 wt.-% of at least one polyamide (B) having a melting point Tm in the range from 150 to 204° C., determined according to ISO 3146:2022,
wherein the sum of the polyamides (A) and (B) are 100 wt.-%

The polyamide mixture forms the matrix of the foam particles. Preferably the polyamide foam particles comprise from 80 to 100 wt.-% of the polyamide mixture and 0 to 20 wt.-% of additives (C), more preferably from 85 to 99.9 wt.-% of the polymer mixture and 0.1 to 15 wt.-% of additives (C). Preferably the polymer mixture consists of components (A) and (B). More preferably the polyamide foam particles comprise a polyamide mixture consisting of from 40 to 90 wt.-% of polyamide (A), from 10 to 60 wt.-% of copolyamide (B).

Preferably the at least one polyamide (A) and the at least one polyamide (B) are both selected from partially crystalline polyamides. More preferably the polyamide mixture consists of partially crystalline polyamides (A) and (B).

Preferably the polyamide foam particles have at least one melting peak with a melting peak temperature Tp,m in the range from 220 to 240° C., determined by dynamical scanning calorimetry (DSC) according to DIN EN ISO 11357-3: 2018.

Preferably the bulk density the polyamide foam particles is in the range from 50 to 90 kg/m³.

Preferably the polyamide foam particles do not contain any crosslinker, branching agents, or chain extenders, such as multifunctional epoxy-based additives, phosphides, oxazolinones, oxazines, epoxides, oxazolines, caprolactams, anhydrides, acid chlorides, aldehydes, amines, carboxy compounds, carbodimides, styrene or acrylate based malic anhydride copolymers and/or iso cyanates.

### Polyamide (A)

The at least one polyamide (A) may be a homopolyamide obtained from polymerization of lactams, such as caprolactames or lauryllactames, condensation products of diamines and dicarboxylic acids, copolyamides thereof or mixtures of two or more different polyamides.

Preferably the at least one polyamide (A) is selected from partially crystalline polyamides having a melting point Tm in the range from 205 to 320° C. more preferably in the range from 210 to 230° C. determined according to ISO 3146:2022.

Preferably polyamides (A) have a crystallinity of more than 20%, more preferably in the range from 25 to 60%, determined by means of differential scanning calorimetry (DSC) according to DIN EN ISO 11357-3:2018 by integration of the melting signal, i. a crystallinity of 100% corresponds to 230 J/g (Journal of Polymer Science Part B Polymer Physics 35 (1997) 2219-2231).

Preferably polyamide (A) comprises at least one polyamide selected from the group consisting of polycaprolactam (PA6), polybutylene adipamide (PA 4.6), polyhexamethylene adipamide (PA 6.6), polyhexamethylene sebacamide (PA 6.10), polyhexamethylene dodecanamide (PA 6.12), poly-mxylylene adipamide (PAMXD 6), PA 6 6T/6I, PA 6.12), PA9T, polybutylene sebacamide (PA 4.10), polypentamethylene adipamide (PA 5.6) and copolymers and PA 66/6, 6T/6.6, and their transamidation products.

Most preferably the at least one polyamide (A) is selected from the group consisting of polycaprolatam (PA6), polyhexamethylene adipamide (PA 6.6), poly-hexamethylene sebacamide (PA 6.10), polyhexamethylene dodecanamide (PA 6.12), PA 66/6 or mixtures therefrom.

| | | Melting point |
|---|---|---|
| Abbreviation | Monomers | Tm |
| PA 6 | caprolactam | 220 |
| PA 4.6 | 1,4-diaminobutane, adipic acid | 294 |
| PA 6.6 | Hexamethylendiamine, adipic acid | 260 |
| PA 6.10 | Hexamethylendiamine, sebacic acid | 240 |
| PA 6.12 | Hexamethylendiamine, decandicarboxylic | 212-217 |
| | acid | |
| PA MXD6 | m-xylylenediamie, adipic acid | 240 |
| PA 4.10 | 1,4-diaminobutane, sebacic acid | 250 |
| PA 9T | 1,9-Diaminononane, terephthalic acid | 290 |
| PA 5.6 | Pentamethylenediamine, adipic acid | 251 |
| PA 66/6 | Hexamethylendiamine, adipic | 205-240 |
| | acid/Caprolactam/ | |
| PA 6T/6.6 | Hexamethylendiamine, terephtalic acid, | 310 |
| | adipic acid | |
| PA 6 6T/6I | Caprolactam, Hexamethylendiamine, | 320 |
| | Polyphtalamidterephthalic acid, isophoric | |
| | acid | |

### Polyamide (B)

The at least one polyamide (B) may be a homopolyamide obtained from polymerization of lac-tams, such as caprolactames or lauryllactames, condensation products of diamines and dicarboxylic acids, copolyamides thereof or mixtures of two or more different polyamides.

Preferably the at least one polyamide (B) is selected from partially crystalline polyamides having a melting point Tm in the range from 150 to 204° C., more preferably in the range from 180 to 200° C. determined according to DIN EN ISO 11357-3: 2018.

Preferably polyamide (B) comprises at least one polyamide selected from the group consisting of polylaurolactam (PA12), Poly-11-aminoundecanamide (PA 11)198, polydecamethylene sebacamide (PA 10.10 203-204), and copolyamide PA 6/66 180-200, (PA6/6.36) or mixtures therefrom.

| Abbreviation | Monomers | Melting point Tm |
|---|---|---|
| PA 12 | Laurolactam | 178 |
| PA11 | 11-aminoundeanoic acid | 190 |
| PA 10.10 | Decamethylendiamine, sebacic acid | 203-204 |
| PA 6/6.36 | Caprolactam/Hexamethylendiamine, | 199 |
| | C₃₆ dimer acid | |
| PA 6/66 | Caprolactam/Hexamethylendiamine, | 180-204 |
| | adipic acid | |

Preferably the at least one polyamide (B) is a copolyamide prepared by polymerizing the following components
(B1) from 15 to 84 wt.-% of at least one lactam,
(B2) from 16 to 85 wt.-% of monomer mixture (M) comprising,
   (M1) at least one C₃₂-C₄₀ dimer acid and
   (M2) at least one C₄-C₁₂ diamine,
wherein the sum of the components (B1) and (B2) are 100 wt.-%.

Component (B1) is at least one lactam. Suitable lactams are selected, for example, from the group consisting of 3-aminopropanolactam (propio-3-lactam; β-lactam; β-propiolactam), 4-aminobutanolactam (butyro-4-lactam; γ-lactam; γ-butyrolactam), 5-aminopentanolactam (2-piperidinone; δ-lactam; δ-valerolactam), 6-aminohexanolactam (hexano-6-lactam: ε-lactam; ε-caprolactam), 7-aminoheptanolactam (heptano-7-lactam; ζ-lactam; ζ-heptanolactam), 8-aminooctanolactam (octano-8-lactam; η-lactam; η-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam).

The lactams may be unsubstituted or at least monosubstituted. Suitable substituents are, for example, methyl, ethyl, propyl, isopropyl, n-butyl, sec-butyl and tert-butyl, cyclohexyl, phenyl and anthranyl.

Preference is given to using unsubstituted lactams, preference being given to γ-lactam (γ-butyrolactam), δ-lactam (δ-valerolactam) and ε-lactam (ε-caprolactam). Particular preference is given to δ-lactam (δ-valerolactam) and ε-lactam (ε-caprolactam), especial preference to ε-caprolactam.

Component (M1) is especially preferably at least one C₃₆ dimer acid. The at least one C₃₆ dimer acid is preferably prepared proceeding from unsaturated C₁₈ fatty acids. More preferably, the C₃₆ dimer acid is prepared proceeding from C₁₈ fatty acids selected from the group consisting of petroselic acid ((6Z)-octadeca-6-enoic acid), oleic acid ((9Z) octadeca 9 enoic acid), elaidic acid ((9E) octadeca-9-enoic acid), vaccenic acid ((11E)-octadeca-11-enoic acid) and linoleic acid ((9Z,12Z)-octadeca-9,12 dienäsure). In the preparation of component (M1) from unsaturated fatty acids, trimer acids may additionally form; residues of unreacted unsaturated fatty acid may also remain.

Preferably, component (M2) is selected from the group consisting of tetramethylenediamine, pentamethylenediamine, hexamethylenediamine, decamethylenediamine and dodecamethylenediamine

According to the invention, the at least one copolyamide (B) has been prepared by polymerizing 15% to 84% by weight of component (B1) and 16% to 85% by weight of component (B2); preferably, the copolyamide has been prepared by polymerizing 40% to 83% by weight of component (B1) and from 17% to 60% by weight of component (B2); especially preferably, the at least one copolyamide has been prepared by polymerizing from 60% to 80% by weight of component (B1) and 20% to 40% by weight of component (B2), where the sum of the components (B1 and (B2) are 100%.

The polymerization of components (B1) and (B2) may take place in the presence of a catalyst. Suitable catalysts are all catalysts that are known to those skilled in the art and catalyze the polymerization of components (B1) and (B2). Catalysts of this kind are known to those skilled in the art. Preferred catalysts are phosphorus compounds, for example sodium hypophosphite, phosphorous acid, triphenylphosphine or triphenyl phosphite.

The polymerization of components (B1) and (B2) forms the copolyamide, which therefore receives structural units derived from component (B1) and structural units derived from component (B2). Structural units derived from component (B2) comprise structural units derived from components (M1) and (M2).

Preferably the copolyamide is a random copolymer.

The copolyamide typically has a glass transition temperature (Tg) the range from 20 to 50° C., preferably in the range from 23 to 47° C. and especially preferably in the range from 25 to 45° C., determined according to DIN EN ISO 11357-2: 2018 The copolyamide typically has a melting point (Tm) in the range from 150 to 204° C., preferably in the range from 160 to 202° C. and especially preferably in the range from 180 to 200° C., determined according to DIN_EN_ISO_3146:2022.

The copolyamide generally has a viscosity number (VN) in the range from 150 to 300 mL/g, determined in a 0.5% by weight solution of the at least one copolyamide in a mixture of phenol/o-dichlorobenzene in a weight ratio of 1:1. Preferably, the viscosity number (VN) of the at least one copolyamide is in the range from 160 to 290 mL/g and more preferably in the range from 170 to 280 mL/g, determined in a 0.5% by weight solution of the at least one copolyamide in a mixture of phenol/o-dichlorobenzene in a weight ratio of 1:1.

### Additives (C)

The polyamide foam particles may comprise further additives (C), such as nucleating agents, dyes, pigments, flame retardant, waxes, antioxidants, stabilizers, IR-absorber and/or inorganic fillers.

Heat stabilizers or antioxidants, or a mixture of these, may be selected from the group of the copper compounds, sterically hindered phenols, sterically hindered aliphatic amines, and/or aromatic amines. Preferred salts of monovalent copper are cuprous acetate, cuprous chloride, cuprous bromide, and cuprous iodide, which can be used in combination with potassium or sodium halogenides e.g. potassium iodide.

Examples that of oxidation retarders and heat stabilizers are phosphites, e.g. (sodium hypo phosphite) and further amines, hydroquinones, various substituted representatives of these groups, and their mixtures. UV stabilizers that may be mentioned are various substituted resorcinols, salicylates, benzotriazoles, and benzophenones.

Secondary aryl amines and/or oligomeric amine may be used as stabilizers. Preferred oligomeric amine contain 0.1 to 2.0 wt.-% of at least one secondary aryl amine and/or at least one condensation product of secondary aryl amines and aliphatic aldehydes, aliphatic ketones, or mixtures thereof. This stabilizer is commercially available as Okaflex® from Oka-Tec.

Other secondary aryl amines are commercially available as Naugard® 445 (from SI Group Sales Germany (DEAB) GmbH) or Flexamin® GR (from SI Group Sales Germany (DEAB) GmbH).

Preference is given to nucleating agents such as talc, paraffins, waxes, carbon black, graphite, pyrogenic silicas, natural or synthetic zeolites or bentonites in order to adjust the cell structure. The total amounts of all additives (C) are preferably in the range from 0 to 20 wt.-% in addition to 100% of the polyamide mixture. The total amount of the additives (C) is more preferably in the range from 0.1 to 15 wt.-%, based on 100% of the polyamide mixture, most preferably based on 100% of the sum of components (A) and (B). Preferably the polyamide particles comprise (C) from 0 to 5 wt.-%, more preferably from 0.1 to 1 wt. % in addition to the sum of the components (A) and (B) of a nucleating agent. Preferably the nucleating agent is talcum. The sum of the components (A) and (B) is preferably 100%, based on all polymeric components of the polyamide foam particles.

The invention further provides a process for preparing the above-mentioned polyamide foam particles comprising the steps of
a) preparing granulates comprising at least one polyamide (A), at least on polyamide (B) and optionally further additives (C)
b) impregnating the polymer granulates in suspension under pressure with at least one blowing agent by maintaining the polymer grates for 10 to 100 minutes at an impregnation temperature (IMT) at a temperature in the range from 115-265° C.,
c) expanding the impregnated polymer granules by releasing the pressure to produce polyamide foam particles.

Preference is given to using cylindrical, ellipsoidal or spherical granulates having an average diameter of from 0.2 to 10 mm, in particular from 0.5 to 5 mm. In the case of cylindrical or ellipsoidal granulates, the diameter is for the present purposes the longest dimension. The individual granulates generally have an average mass in the range from 1 to 50 mg, preferably the range from 5 to 25 mg. This average mass of the pellets (particle weight) is determined as arithmetic mean by triplicate weighing of in each case 10 pellets. These preferably cylindrical or round pellets can be produced by all compounding processes known to those skilled in the art with subsequent palletization as cold or hot cutting.

The granulates are suspended in a suitable suspension medium, for example water, polar organic solvents such as alcohols, ketones or mixtures thereof. In general, water is used as suspension medium. The density of the suspension medium can be adjusted by using soluble salts like sodium sulfate. In general, the amount of the suspension medium is selected so that the phase ratio as weight ratio of the granulates to suspension medium is in the range from 0.2 to 0.9.

In order to achieve uniform distribution of the pellets in the suspension medium, suspension aids are generally added. Suitable suspension aids are water-insoluble inorganic stabilizers such as tricalcium phosphate, magnesium pyrophosphate, metal carbonate such as calcium carbonate and also polyvinyl alcohol and ionic or nonionic surfactants. The suspension aids are usually employed in amounts of from 0.01 to 5% by weight.

In step b), a blowing agent is added. Volatile substances having a boiling point at atmospheric pressure in the range from −10 to 125° C. or gases such as carbon dioxide or nitrogen are generally used. The bulk density, cell structure and crystallinity of the polymer matrix can be influenced by the choice of the type and amount of the blowing agent. Preferably a hydrocarbon having from 3 to 6 carbon atoms, in particular n-butane an isobutane, carbon dioxide, nitrogen or a mixture thereof is used as blowing agent. The blowing agents are generally used in amounts of from 1 to 50% by weight, based on the granulates.

The impregnation in step b) is preferably carried out at an impregnation temperature IMT in the range from 145 to 165° C., more preferably in the range from 150 to 160° C.

The impregnation in step b) is preferably carried out by heating the suspension at a heating rate of 2° C./min or above to the impregnation temperature (IMT) and keeping it at a temperature in the range from 2° C. above the impregnation temperature (IMT) to 5° C. below the impregnation temperature (IMT) for a period of from 2 to 100 minutes, more preferably of from 5 to 50 minutes, most preferably from 15 to 30 minutes.

Depending on the type and amount of the blowing agent and the temperature or the treatment with a gas, an impregnation pressure (IMP) is established in the closed vessel. The impregnation in step b) is preferably carried out at an impregnation pressure IMP in the range from 150 to 5500 kPa particularly preferably in the range from 500 to 4000 kPa absolute.

Preferably in step b), the pressure vessel is supplied with nitrogen at a temperature of the suspension in the range from 30 to 75° C. so that an impregnation pressure IMP in the range from 500 to 4000 kPa is established.

The blowing agent-comprising pellets obtained in step b) are foamed to give foam particles by depressurization in a subsequent step c). The depressurization of the suspension in step c) is generally effectuated by emptying the pressure vessel via an opened shut-off valve into an expansion vessel. As shut-off valve, it is possible to use a valve, a slider, a cock or a flap, with preference being given to ball valves. During emptying of the pressure vessel, the suspension can be depressurized directly to atmospheric pressure (1013 Pa) or in an intermediate vessel having a gauge pressure in the range from 100 to 1000 kPa. The depressurization of the suspension in step c) is preferably effectuated by emptying the pressure vessel via a ball valve into an expansion vessel.

The suspension is preferably brought into contact with a liquid coolant downstream of the depressurization device in step c).

In an optional work-up step, the suspension aids which have been used and are still adhering to the foam particles can be removed from the foam particles obtained. The foam particles are subsequently washed and separated off from the liquid phase by filtration or centrifugation and then dried.

The invention further provides a process for preparing polyamide particle foam moldings by steam-chest molding of polyamide foam particles as described above at a temperature in the range from temperature in the range from 100 to 180° C., preferably in the range from 140 to 170° C. and polyamide particle foam moldings obtainable according to this process.

The polyamide foam particles according to the invention are processable on standard steam chest molding equipment with steam pressure between 2-4 bar to halogen-free particle foam moldings with high thermal oxidative stability. They show high compression and tensile strength after storage for more than 500 hours at increased temperatures or increased temperatures and increased humidity.

The polyamide particle foam moldings according to the invention may be used for reinforcement of structural parts in the automotive, aerospace and consumer industry. Further applications are for car body structures, engine parts, protective parts of BEVs or as core element for sandwich parts, especially in combination with reactive injection molding. The polyamide foam moldings may be combined with non-foamed polyamide parts for improved recyclability via one material approach.

### EXAMPLES

Hereinafter, the present invention is described in more detail and specifically with reference to the Examples, which however are not intended to limit the present invention.

### Raw Materials:

PA-A: Ultramid® Flex F 38, Copolyamide 6/6.36, BASF SE, density 1060-1090 kg/m³, relative Viscosity (RV) 3.7-3.9, melting point (Tm) 199° C.,
PA-B: Ultramid® B40, Polyamide 6, BASF SE, density 1120-1150 kg/m³, viscosity number (VN) 240-260 ml/g, melting point (Tm) 220° C.
D1: Calcium carbonate, CaCO3, (dispersant agent)
D2: Lutensol AT25, non-ionic surfactant
D3: Disponil LDBS 25, anionic surfactant
Nu: Talcum IT
BA1 n-butane
BA2 N₂
BA3 CO₂

### Test Methods:

### Bulk Density:

The determination of the bulk density of the foamed polyamide particles (EPA) was carried out by a method based on to DIN ISO 697: 1984. Here, the foam particles were introduced into a measuring cylinder having a known volume with the aid of a funnel having a predetermined geometry (completely filled with bulk material), the excess of the bulk material was struck off from the measuring cylinder by means of a straight-edged bar and the contents of the measuring cylinder were determined by weighing.

The funnel used has a height of 40 cm, an opening angle of 35° C. and an outlet having a diameter of 50 mm. The measuring cylinder had an internal diameter of 188 mm and a volume of 10 l.

The bulk density (BD) is given by the mass of the beads divided by the volume of the cylinder [kg]/0.01 [m³]. The average of 3 measurements in kg/m³ was reported as bulk density.

The particle bulk density of the expanded granulates was determined in accordance with to DIN ISO 697: 1984.

### Melting Point Tm and Melting Peak Temperature Tp,m

Melting point Tm of the polyamide raw materials and polyamide precursor were determined according to ISO 3146:2022 (Plastics—Determination of melting behaviour (melting temperature or melting range) of semi-crystalline polymers by capillary tube, method A):

Melting peak temperature Tp,m was determined by DSC according to DIN EN ISO 11357-3: 2018

Procedure in accordance with ISO 11357-3 (German version of Apr. 1, 2018) using a DSC Q100 from TA Instruments. To determine the melting peak temperature Tp,m of the polyamide granulates, 3-5 mg are heated at a heating rate of 20° C./min in a 1st run between 20° C. and 200° C., subsequently cooled at 10° C./min to 20° C., followed by a further heating cycle (2nd run) at a heating rate of 10° C./min. The temperature of the peak maximum in the 2nd run was reported as melting peak temperature Tp,m.

### Crystalline Structure by DSC:

To characterize the crystalline structure of the compact polyamide granulates or the expanded foam particles, 3-5 mg are heated at a heating rate of 20° C./min between 20° C. and 200° C. and the resulting heat flow is determined.

The relative crystallization degree was determined by differential scanning calorimetry (DSC) by integration of the melting signal, i. a crystallinity of 100% corresponds to 230 J/g (Journal of Polymer Science Part B Polymer Physics 35 (1997) 2219-2231). The measurement is carried out according to the invention according to DIN EN ISO 11357_3: 2018

### Polyamide Foam Particle Moldings:

Density of the polyamide foam particle moldings (molded part) is measured according to DIN EN ISO 845-10:2009.

Heat deflection temperature was measured according to DIN 53424:1978 in range of 20-230° C. with Gabo Eplexor 500 and a frequency of 1 Hz. Dryed samples (7 d/80° C./Vakuum) were used.

Storage Modulus E′ was determined by DMTA according to ISO 6721-1:2019) in range of −50 until 230° C. with Gabo Eplexor 500 and a frequency of 1 Hz. Dryed samples (7 d/80° C./Vakuum) were used.

The specific bending strength is calculated by max bending strength in N divides by the part density [kg/m³].

### Specific Heat Stability (° C.*L/g)

The specific heat stability is calculated by measurement of heat defection temperature divided by the part density which was measured. The Heat deflection temperature was measured according to DIN 53424:1978 in range of 20-230° C. with Gabo Eplexor 500 and a frequency of 1 Hz. Dryed samples (7 d/80° C./Vakuum) were used. The part density according to DIN EN ISO 845-10:2009

### Closed Cell Ratio

The volume fraction of closed cells and cell walls so called closed cell ratio yr was determined via DIN EN ISO 4590_Process 2b. The measurement device that was used Accupyc 1330 is produced from micromeritics. The closed cell ratio ψr was calculated via following equation where ωr the Volume fraction of open cells was. ωr had to be calculated via equation 2. Vg corresponds to the sample volume. The sample volume was measured via the geometrical sample data (3). The rough sample size was 30*30*25 mm. Vi corresponds to the sample volume of the specimen into which no air enters under test conditions and from which no gas can escape. Vi was be measured via the measurement tool Accupyc 1330.

ψr=100−ωr (1)

ωr=[(Vg−Vi)/Vg]×100 (2)

Vg=2×[(A1+A2)/2×(B1+B2)/2×(C1+C2)/2]

To evaluate the stability against thermal ageing, test cubes according to ISO844 were prepared from the polyamide particle foam moldings and compression strength measured at 10% compression before and after storage for 2000 hours at 120° C. and 150° C. in dry air.

### Experimental Setup and Description of Experiments

### Preparation of Polyamide Precursor (PA-A/PA-B-Blend)

For the precursor production, 50 parts by weight of polyamide PA-A (polyamide Flex F 38, PA 6/6.36) and 49 parts per weight of polyamide PA-B (Ultramid B40, PA 6) are used. An extruder was used. The polyamides and the other components, such as talcum IT extra are charged without heating to the extruder from Coperion Waeschle GmbH [ZE A-UTX]. The screw diameter was 40 mm.

The extruder screw speed was set to 200 rpm. All the polymers were melted, and other additives were incorporated into the melt. Total throughput was 60 kg/h. The entire mixture was pressurized by way of an incoming-pressure-controlled gear pump installed at the extruder outlet. The pressurized melt passed a bypass valve and flow into the die (4*1 mm) of the underwater pelletizer, which was equipped with 10 knifes. The die plate temperature was set to 310° C., the water temperature was 70° C. and no water pressure was applied (~1 bar). The average particle weight and bulk density was measured. Melting peak temperature Tp,m of the PA-A/PA-B-Blend was 217° C.

The particle weight was 6.3 mg particles, which were achieved by a knife speed of 1325 rpm Bulk density ~600 g/L

### Examples 1 to 3 and Comparative Example C1 and C2

### Preparation of Polyamide Foam Particles (EPA) by Suspension Impregnation

The autoclave foaming of the polyamide material using n-butane and nitrogen 0.3 kg as blowing agent was run in the autoclave pilot plant. This is a batch process with volume of ~50 L: the polymer beads 8 kg are immersed in water (Phase ration from liquid to solid material was 0.2) and put in contact with the blowing agent n-butane (24%) in the so-called impregnation vessel. The fill level of the autoclave was 80%. Additionally, the surfactant (Disponil) (w/w water %) 0.018% was added. The temperature is increased, and pressure increases accordingly.

Agitation −300 1/min promotes the contact between liquid n-butane, in the form of droplets, and the polymer beads. In this way n-butane is impregnated in the polymer until saturation is reached. A constant temperature plateau at the end of the impregnation curve at 157.5° C. for 30 min was adjusted. In a subsequent step, the pressure of the vessel is risen to ca. 40 bar through nitrogen addition following which the bottom valve of the vessel is flash-opened, letting the content of the vessel flow into the pressure-less vessel below it which was prefilled with water. At this point in time, due to the sudden pressure and temperature change, the n-butane dissolved and created a foamed particle. The particles are cooled down with additional water for 20 min and later exit this vessel through its bottom valve into a centrifuge. Lastly, the moist particles are dried with 60° C. warm air in a fluidized bed drier for 2 h. The bulk density of the foamed polyamide particles was 65 g/L. The high melting peak temperature Tp,m of the foamed polyamide particles (EPA) are indicated in Table 1.

### Steam-Chest Molding

The pre-expanded particles were pre-pressurized for ~23 h with 2.5 bar air. Then the material was loaded into the cavity of a mold by injection with compressed air (cavity dimensions: 300 mm in length, 200 width and 25 mm in height). 5 mm crack filling was applied. The mold was installed in a molding machine. Thereafter, the pre-expanded particles were molded by supplying 145° C. saturated steam into the cavity for 25 seconds (cross steam heating), and subsequently supplying 150° C. saturated steam into the cavity for 20 seconds (Autoclave steam heating) via thermal fusion of the pre-expanded particles. Cooling air was supplied into the cavity of the mold for 30 seconds to cool the resultant shaped and welded product. The wet part density was 91 g/L. After 8 h/80° C. drying the part density was 86 g/L.

The processing of the expanded particles to a molded part, was carried out with a standard EPP chest molding machine (Erlenbach EHV-C PP 870×670) in a mold with the dimensions 200×300×25 mm. The beads were fused with cross and autoclave steam with steam pressure of 2-5 bar.

The molded parts were dried for 8 h at 80° C. (air) and then specimens with a dimension 40×40×25 mm were prepared. The specimens were stored for 14 d 70° C. 62% rF prior bending strength were tested. To The specific bending strength is calculated by max bending strength in N divides by the part density [kg/m³]

### Comparative Examples C3 and C4 (Melt Extrusion Impregnation)

Comparative Examples C3 and C4 were prepared by melt impregnation as described in WO 2021/052881, example 4. The expanded polyamide particles obtained in Comparative Example C4 were further foamed to lower density by commercial pre-foamer.

### Comparative Example C5

Expandable particles were prepared from a mixture of 40 parts per weight of Ultramid® B36 (PA 6) and 60 parts per weight of Grivory G16 (PA 6I/6T) were mixed by melt a melt-impregnation process with 1 part per weight of talcum, 1.5 parts per weight of water and 1 part per weight of isopentane as described in Comparative Example C1 in WO 2021/052881. The obtained expandable particles with a density of 630 kg/m³ were pre-foamed to foam particles with a bulk density of 340 kg/m³ and converted to particle foam moldings with a part density of 590 kg/m³ as described in Comparative Example C1 in WO 2021/052881.

TABLE 1
Composition (parts per weight) and properties of foam particles
of Examples 1 to 3 and Comparative Examples C1 to C4

| Example | 1 | C1 | 2 | 3 | C2 | C3 | C4 |
|---|---|---|---|---|---|---|---|
| PA-A | 50 | 50.0 | 50.0 | 50 | 50 | 50 | 50 |
| PA-B | 49.5 | 49.5 | 49.5 | 49.5 | 49.5 | 49.5 | 49.5 |
| Nu | 0.5 | 0.5 | 0.5 | 0.5 | 0.5 | 0.5 | 0.5 |
| BA1 | n-butane | n-butane | n-butane | n-butane | n-butane | | |
| BA2 | N2 | N2 | N2 | N2 | N2 | N2 | N2 |
| BA3 | | | | | | CO2 | CO2 |
| D1 | | | 6.66 | 6.66 | 6.66 | | |
| D2 | | | 0.125 | 0.125 | 0.125 | | |
| D3 | 0.006 | 0.006 | | | | | |
| melting peak | 217 | 217 | 217 | 217 | 217 | 217 | 217 |
| temperature | | | | | | | |
| Tp, m [°C] | | | | | | | |
| (PA-A/PA-B- | | | | | | | |
| Blend) | | | | | | | |
| IMT [°C] | 157 | 156 | 157 | 160 | 155 | | |
| Time at IMT | 30 | 60 | 30 | 30 | 30 | | |
| Bulk density | 65 | 126 | 88 | 59 | 644 | 360 | 200 |
| of foam | | | | | | | |
| particles | | | | | | | |
| [kg/m³] | | | | | | | |
| melting peak | 230 | 230 | 230 | 230 | 230 | 219 | 219 |
| temperature | | | | | | | |
| Tp, m [°C] of | | | | | | | |
| foam | | | | | | | |
| particles | | | | | | | |

TABLE 2
Process conditions for steam-chest molding (Mold 300*200*25 mm)

| | | | | | | | Autoclave steam heating | | | | |
|---|---|---|---|---|---|---|---|---|---|---|---|
| | | | | | | | | | | | Part |
| | Foam | Pre | | | | | | | | | density |
| | Particle | Pressuri | Crack | Cross steam heating | | | | | | Water | after drying |
| | [symbol] | [symbol] | filling | Time | Pressure | Temperature | Time | Pressure | Temperature | cooling | 70 °C for |
| Example | [g/L] | Bar /h | [mm] | [s] | [bar] | °C | [s] | [bar] | [°C] | [s] | 16 h |
| 1 | 65 | 4/18 | 3 | 40 | 4 | 145 | 20 | 5.5 | 150 | 30 | 84 |
| C1 | 126 | 4/18 | 10 | 40 | 4 | 145 | 20 | 5.5 | 150 | 30 | 186 |
| 2 | 88 | 4/18 | 3 | 40 | 4 | 145 | 20 | 5.5 | 150 | 30 | 110 |
| 3 | 59 | 4/18 | 3 | 40 | 4 | 145 | 20 | 5.5 | 150 | 30 | 79 |
| C2 | 644 | No | | | | | | | 150 | | |
| | | welding | | | | | | | | | |
| C3 | 360 | | 6.0 | 7 | 4 | 145 | 12 | 4.0 | 144 | 20 | 526 |
| C4 | 200 | 2.5/4 | 3 | 10 | 4 | 145 | 8 | 4 | 145 | 10 | 355 |
| C5 | 340 | | 14 | 3 | 1.3 | 107 | 8 | 1.4 | 109 | 10 | 590 |

[symbol]

indicates data missing or illegible when filed

TABLE 3
Mechanical properties of foam moldings

| Example | 1 | C1 | 2 | 3 | C2 | C3 | C4 | C5 |
|---|---|---|---|---|---|---|---|---|
| Density molded Part | 84 | 186 | 110 | 79 | — | 526 | 355 | 590 |
| (g/L) | | | | | | | | |
| Closed cell ratio | 94 | 43 | 73 | 75 | | | 81 | |
| Specific bending strength | 1.49 | 0.22 | 0.96 | | | | 0.6 | |
| (N* m³/kg) | | | | | | | | |
| Specific heat stability | 2.2 | | | | | 0.41 | 0.6 | 0.36 |
| (°C*L/g) | | | | | | | | |

1.-18. (canceled)

19. Polyamide foam particles having bulk density in the range from 10 to 95 kg/m³, as determined according to DIN ISO 697: 1984, comprising a polyamide mixture of:
from 25 to 95 wt.-% of at least one polyamide (A) having a melting point Tm in the range from 205 to 320° C., as determined according to ISO 3146:2022, and
from 5 to 75 wt.-% of at least one polyamide (B) having a melting point Tm in the range from 150 to 204° C., as determined according to ISO 3146:2022,
wherein the sum of the polyamides (A) and (B) are 100 wt.-%.

20. Polyamide foam particles according to claim 19, wherein the at least one polyamide (B) is a copolyamide prepared by polymerizing the following components
(B1) from 15 to 84 wt.-% of at least one lactam,
(B2) from 16 to 85 wt.-% of monomer mixture (M) comprising,
(M1) at least one C₃₂-C₄₀ dimer acid and
(M2) at least one C₄-C₁₂ diamine,
wherein the sum of the components (B1) and (B2) are 100 wt.-%.

21. Polyamide foam particles according to claim 19, wherein the at least one polyamide (A) is selected from the group consisting of polycaprolatam (PA6), polyhexamethylene adipamide (PA 6.6), poly-hexamethylene sebacamide (PA 6.10), polyhexamethylene dodecanamide (PA 6.12), PA 66/6 or mixtures therefrom.

22. Polyamide foam particles according to claim 19, wherein the foam particles comprise of from 80 to 99.9 wt.-% of the polymer mixture consisting of polyamide (A) and (B), and from 0.1 to 15 wt.-% of additives (C), selected from the group of nucleating agents, dyes, pigments, flame retardant, antioxidants, stabilizers, IR-absorber and/or inorganic fillers.

23. Polyamide foam particles according to claim 19, wherein the bulk density is in the range from 50 to 90 kg/m³.

24. Polyamide foam particles according to claim 19, having at least one melting peak with a melting peak temperature Tp,m in the range from 220 to 240° C., as determined by dynamical scanning calorimetry (DSC) according to DIN EN ISO 11357-3: 2018.

25. A process for preparing polyamide foam particles according to claim 19, comprising the steps of:
a) preparing granulates comprising at least one polyamide (A), at least on polyamide (B) and optionally further additives (C);
b) impregnating the polymer granulates in aqueous suspension under pressure with at least one blowing agent by maintaining the polymer grates for 10 to 100 minutes at an impregnation temperature (IMT) in the range from 115 to 265° C.; and
c) expanding the impregnated polymer granules by releasing the pressure to produce polyamide foam particles.

26. The process according to claim 25, wherein 0.1 to 1 wt.-% of talcum, based on 100% of the polyamide mixture (A) and (B), is used as further additive (C).

27. The process according to claim 24, wherein a hydrocarbon having from 3 to 6 carbon atoms, carbon dioxide, nitrogen or a mixture thereof is used as blowing agent.

28. The process according to claim 25, wherein the impregnation in step b) is carried out at an impregnation temperature IMT in the range from 145 to 165° C.

29. The process according to claim 25, wherein the impregnation in step b) is carried out by heating the suspension at a heating rate of 2° C./min or above to the impregnation temperature (IMT) and keeping it at a temperature in the range from 2° C. above the impregnation temperature (IMT) to 5° C. below the impregnation temperature (IMT) for a period of from 2 to 100 minutes.

30. The process according to claim 25, wherein the impregnation in step b) is carried out at an impregnation pressure IMP in the range from 150 to 5500 kPa absolute.

31. The process according to claim 25, wherein, in step b), the pressure vessel is supplied with nitrogen at a temperature of the suspension in the range from 30 to 75° C. so that an impregnation pressure IMP in the range from 500 to 4000 kPa is established.

32. The process according to claim 25, wherein the pressure release of the suspension in step c) is effectuated by emptying the pressure vessel via a ball valve into an expansion vessel.

33. The process according to claim 25, wherein the suspension is brought into contact with a liquid coolant downstream of the depressurization device in step c).

34. A process for preparing polyamide particle foam moldings by steam-chest molding of poly-amide foam particles according to claim 19 at a temperature in the range from 140 to 180° C.

35. Polyamide particle foam moldings, obtainable according to the process of claim 34.

36. Use of the polyamide particle foam moldings according to claim 35 in the automotive, aerospace and consumer industry.
